(19) United States
(12) Patent Application Publication
(10) Pub. No.: US 2003/0108413 A1
(43) Pub. Date: Jun. 12, 2003

(54) Load lifting attachment for skid-steer loader

(76) Inventor: Walter Bruce Pemberton, Fern Park, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/016,304

(22) Filed: Dec. 10, 2001

(51) Int. Cl. B66F 11/00

(52) U.S. Cl. 414/685

(57) ABSTRACT

A load lifting attachment (30) for increasing the load lifting capacity of a skid-steer loader (62). A lifting mechanism (40) is supported from a C-shaped frame member (32). The frame member has a hard coupling (72) to a boom arm (70) of the skid-steer loader and a pair of caster assemblies (38) at opposed ends. A load supported on the load-bearing forks (42) of the lifting mechanism has its center of gravity proximate the swivel axis of the caster assemblies in order to minimize the resultant loads on the boom arm. The forks extend beyond the wheels (36) of the caster assemblies to allow the device to carry wide loads and to lift loads from a shelf blocking the forward movement of the wheels. An inclinometer (74) is provided to assist the operator in avoiding unstable movements. In one embodiment, the lifting capacity of a skid-steer loader is increased from 1,700 pounds to 5,000 pounds with the addition of the load lifting attachment.

### FIELD OF THE INVENTION

This invention relates generally to the field of load lifting equipment, and more particularly to skid-steer loaders, and specifically to an attachment for increasing the lifting and handling capability of a skid-steer loader and a method for using a skid-steer loader having such an attachment.

### BACKGROUND OF THE INVENTION

Skid-steer loaders are well known in the art. One line of skid-steer loaders is sold under the trademark “Bobcat” by the Bobcat Company. (www.bobcat.com) Skid-steer loaders are useful for handling relatively light loads. For example, a typical skid-steer loader with a standard pallet fork attachment may be rated for lifting and handling pallet loads of up to 1,700 pounds. This lifting capacity is limited by the relatively light weight of the skid-steer loader, since lifting heavier loads will cause the rear wheels of the loader to lift off of the ground. A larger, heavier loader would be capable of lifting a heavier load. However, larger, heavier machines tend to be more expensive and less maneuverable than smaller machines, so a trade-off must be made between lifting capacity and loader size.

Devices have been developed to increase the lifting capability of a skid-steer loader without sacrificing the small size and weight of the loader. U.S. Pat. No. 5,685,563 describes a counterbalance system for a short wheelbase vehicle. This system uses a moveable weight connected to the vehicle frame for providing extra weight over either the front or rear wheels of the vehicle, as desired. While such a system does increase the load lifting capability of the machine, the benefit provided may not justify the complexity of the powered counterweight system.

The inventor is aware of other devices for increasing the lifting capacity of a skid-steer loader. FIG. 1 is a side view of a prior art load lifting device 10 attached to the mounting plate 12 of a skid-steer loader boom arm (not shown). FIG. 2 is a front view of the same device. Pallet forks 14 are attached to a lifting frame 16. The forks 14 are moved between a lowered position (shown) and a raised position by the action of hydraulic cylinders 18. The parallelogram shape of the lifting frame 16 allows a caster member 20 located at a far end of the lifting frame 16 to remain in a generally vertical position as the forks 14 are raised and lowered. The load imposed by the forks is shared between the mounting plate 12 and a pair of wheels 22 attached to the caster members 20, thereby increasing the lifting capacity of the skid-steer loader. However, the utility of this device is limited by the projection of the lifting frame 16 and wheels 22 away from the mounting plate 12, since these structures may interfere with the forward movement of the device toward a wall or under a truck or trailer frame. Furthermore, the width of a pallet to be lifted by this device is limited to the width of the inside dimensions of lifting frame 16, since the pallet must pass within the lifting frame structure as it is raised and lowered.

Other types of lifting devices are well known in the art. Fork lifts are specifically designed for the movement of pallets, and they are commercially available in a variety of sizes. The forks of a fork lift are able to carry loads wider than a pallet, but the lifting capacity of these machines is limited. Sod loaders are known for unloading pallets of sod from a trailer and for the movement of the sod around an area to be landscaped. Sod loaders typically have three wheels, with a first wheel on a front portion and two additional wheels on a rear portion that is connected to the front portion by a rotatable hitch connection. These units are steered by hydraulic rotation of the hitch connection, thereby minimizing damage to the underlying surface as the unit is turned. The wheels of the rear portion support a C-frame which in turn supports a fork lift mast for lifting the sod pallets or other wider loads. These specialized machines have limited application beyond sod handling applications due to their small size, limited traction capability and limited maneuverability when compared to a skid-steer machine.

### SUMMARY OF THE INVENTION

Thus what is needed is a skid-steer loader having an increased lifting capacity. A load lifting device is described herein as including: a skid-steer loader having a boom arm; an auxiliary lifting apparatus connected to an end of the boom arm by a hard connection, the auxiliary lifting apparatus further comprising: a generally C-shaped frame member fixedly attached to the end of the boom arm proximate a center of the C-shape; a caster assembly attached proximate each end of the C-shaped frame member; and a lifting mechanism attached to the C-shaped frame member, the lifting mechanism comprising a load-bearing member extending beyond the ends of the C-shaped frame member. A swivel axis of each caster may be disposed in a vertical plane lying proximate a center of the load-bearing member. The lifting mechanism may include a fork having a horizontal length of approximately 60 inches, and wherein the distance between the mounting device and a swivel axis of the caster assembly is approximately 30 inches. An inclinometer may be attached to the device.

A load lifting attachment for a skid-steer loader is described herein as including a frame member including a mounting device for making a hard connection to a boom arm of a skid-steer loader; a caster assembly attached to the frame member opposed the mounting device; and a lifting mechanism attached to the frame member for raising and lowering a load, the lifting mechanism comprising a load-bearing member extending beyond the caster assembly in a direction away from the mounting device. A swivel axis of the caster assembly may be aligned in a vertical plane with a center of the load bearing member. The lifting mechanism may be a fork having a horizontal length of approximately 60 inches, and wherein the distance between the mounting device and a swivel axis of the caster assembly is approximately 30 inches. An inclinometer may be provided attached to the device.

### BRIEF DESCRIPTION OF THE DRAWINGS

The invention will be fully appreciated when the following detailed description is read with reference to the drawings, in which:

FIG. 1 is a side view of a prior art lifting attachment for a skid-steer loader.

FIG. 2 is a front view of the device of FIG. 1.

FIG. 3 is a side view of a lifting attachment for a skid-steer loader.

FIG. 4 is a front view of the device of FIG. 3.

FIG. 5 is a side view of a skid-steer loader with the device of FIG. 3 attached and being operated on its rear wheels.

### DETAILED DESCRIPTION OF THE INVENTION

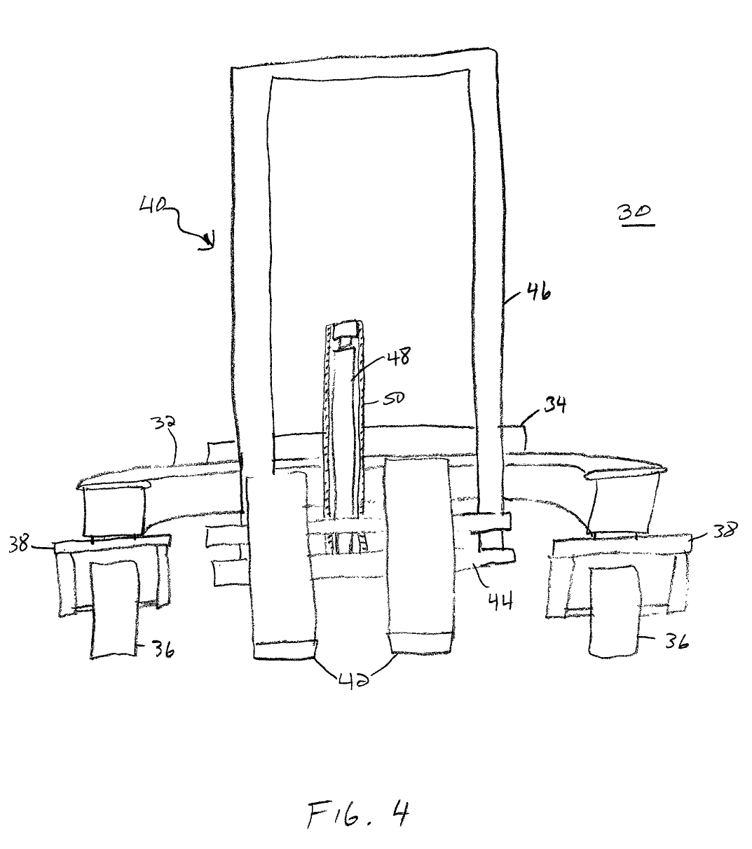

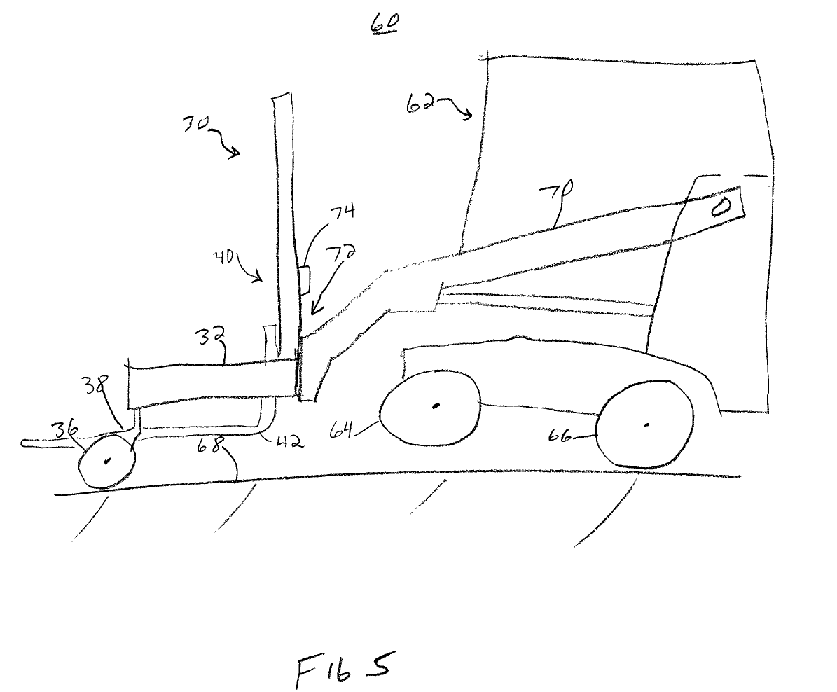

An improved load lifting device 30 is illustrated in FIGS. 3 and 4. The load lifting device 30 is an auxiliary lifting device that is designed for use with a skid-steer loader in order to increase the lifting capacity of the loader. The load lifting device 30 includes a generally C-shaped frame member 32 as viewed from above. One may appreciate that the term “generally C-shaped” as used herein is meant to include a U-shape or other shapes having at least two horizontally extending portions extending away from a central portion. The frame member 32 is a load bearing member and should be sized accordingly, and may be formed of steel, aluminum or high strength composite material, for example. In one embodiment the frame member 32 has a box beam cross-section. A mounting device such as mounting plate 34 is attached to the frame member 32 proximate the center of the C-shape. The mounting plate 34 provides a means for making a hard attachment to the end of a boom arm of a skid-steer loader. The frame member 32 may be connected to the boom arm by any known type of connection, such as a bolt/nut combination, a clamp or vice arrangement, or preferably the type of universal coupler commonly supplied with skid-steer loaders. Mounting plate 34 is designed to make a hard connection with such a universal coupler. Alternatively, the frame member 32 may be attached directly to the boom arm so long as the connection is a hard connection, i.e. one which supports loads and moments in all directions so that the frame member 32 is moved together with the end of the boom arm as an integral unit.

Wheels 36 are rotatably connected to opposed ends of the frame member 32, preferably as part of a corresponding pair of caster assemblies 38. Any commercially available caster assembly 38 having sufficient weight bearing capacity may be used. The caster assembly is preferably selected to have a height such that the frame member 32 may be moved under a trailer for off-loading material from the trailer.

A lifting mechanism 40 is attached to frame member 32 for raising and lowering a load, such as a pallet. In the embodiment illustrated in FIGS. 3 and 4, the lifting mechanism 40 includes a load-bearing member such as tines or forks 42 having a generally L-shape, as are known in the art for handling pallets. The forks 42 may be spaced at a fixed distance from each other, or may be adjustably attached to a fork carriage 44 so that the spacing between the forks 42 may be conveniently changed at the discretion of the operator. The forks 42 and/or fork carriage 44 are slidably supported by mast 46 to move upward and downward between lowered and raised positions. The forks 42 are illustrated as being in a lowered position. Power to raise and lower the forks 42 and any associated load is provided by a hydraulic lift cylinder 48 connected between the fork carriage 44 and the mast 46 and/or frame member 32. Lift cylinder 48 may be a commonly available double-acting fork lift cylinder. Lift cylinder 48 advantageously receives pressurized hydraulic fluid from an auxiliary hydraulic circuit commonly available on skid-steer loaders through quick-disconnect hydraulic line connectors as are known in the art. Appropriate double-acting controls are provided to the operator of the skid-steer loader for raising and lowering the lifting mechanism 40. The lift cylinder 48 may be provided with a mechanical advantage by a chain drive 50, as are common on fork lift masts, to double the range of motion available from the lift cylinder 48. An electric motor or a pneumatic actuator may be used in place of a hydraulic lift cylinder 48.

The operation of lifting device 30 begins by connecting the mounting plate 34 to the lifting boom arm coupler of a skid-steer loader. Hydraulic connections are then made between the skid-steer loader auxiliary hydraulic system and the lift cylinder 48. The forks 42 are raised off of the ground and the skid-steer loader is operated in normal fashion to move the lifting device 30 from place to place. The hard connection provided by mounting plate 34 and the action of the casters 38 allow the lifting device 30 to follow the movement of the skid-steer loader as a single integral unit.

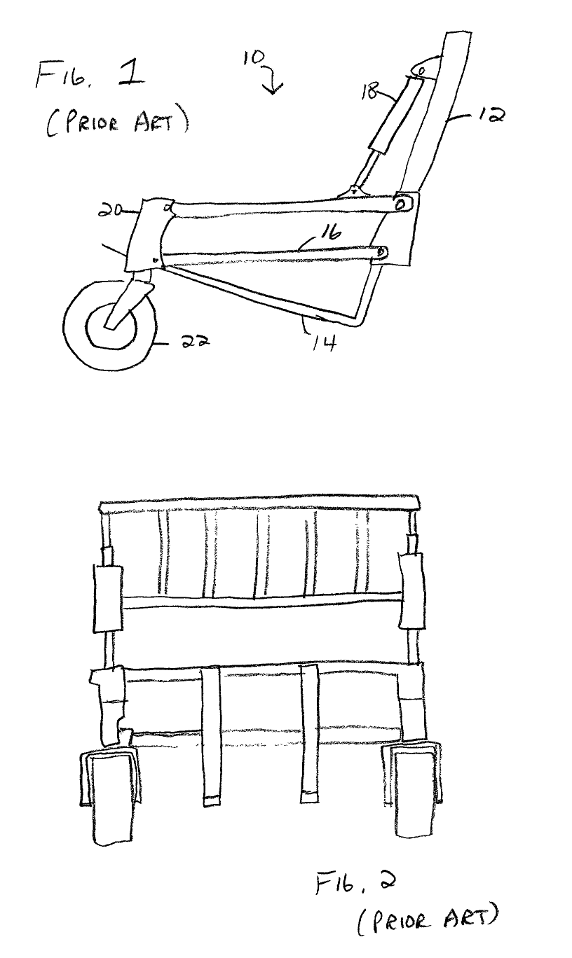

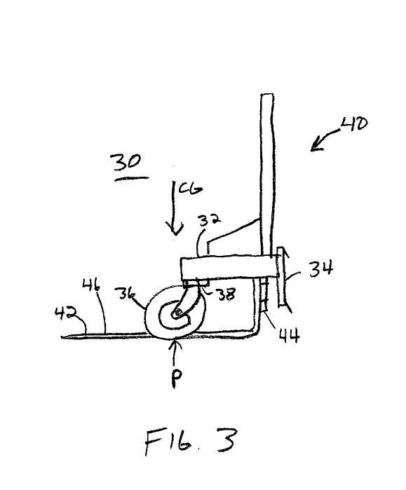

The lifting device may be moved to position the forks 42 under a load, and the lifting mechanism 40 energized to raise and lower the load as desired. Weight applied to the forks 42 is transferred to the frame member 32 which is supported by both the mounting plate 34 and the wheels 36. Because the load is partially supported by the wheels 36, the magnitude of the force exerted onto the skid-steer boom arm is reduced when compared to a standard pallet fork attachment which has no such additional support mechanism. The relative positions of the casters 38 and the center of gravity (CG) of the load tend to reduce the force/moment applied by the load onto the mounting plate 34. Ideally, if the CG of the load is directly above the caster support location as viewed in FIG. 3, there will be zero force/moment imposed on the mounting plate 34. Accordingly, the location of caster 38 is selected so that the point of contact P with the ground is disposed in a vertical plane lying proximate a center of the horizontal portion of the forks 42, i.e. the center of gravity of a load to be supported on the forks 42. One will appreciate that as the skid-steer loader is moved alternately from the forward direction to the rearward direction, the position of the point of contact P will move relative to the frame member 32 due to the rotational action of the casters 38. In one embodiment, the center of the horizontal portion of forks 42 is aligned along a vertical plane with the swivel axis A of the caster 38. In this embodiment, the expected center of gravity CG of a load on the forks 42 will remain proximate the point of contact P for all positions of caster 38. In one such embodiment, lifting device 30 is configured to have the point of contact P of the wheels 36 to be approximately 30 inches forward of the mounting plate 34, with the length of the horizontal portion of forks 42 being approximately 60 inches. Such a device may have a fork lifting capacity of 5,000 pounds when connected to a skid-steer loader that otherwise would have a fork lifting capacity of only 1,700 pounds. The prior art device of FIGS. 1 and 2 also functioned to reduce the load exerted onto the boom arm when compared to a standard pallet fork attachment, however, because of the forwardly extended wheel position, the benefit was not as great as is obtained with the present invention. Other embodiments of the present invention may be envisioned where the center of the horizontal portion of forks 42 extends away from the hard contact location beyond the point of contact P or alternatively does not extend as far as the point of contact P, depending upon the specific requirements of the application regarding weight to be lifted, shape of the load to be lifted, and surrounding obstructions.

The frame member 32 and the caster assembly 38 are also selected to allow forks 42 to extend beyond the forward-most position of wheels 36 away from the location of attachment to the skid-steer loader. This enables the lifting device 30 to be used to lift and to move objects that may be wider than the distance between the wheels 36. An object such as a length of pipe may be placed onto the forks 42 forward of the wheels 36 at a location 46 on the forks 42 and extending beyond the width of the wheels 36 and frame member 32. Furthermore, the geometry of device 30 enables the operator to lift a pallet or other object placed on a shelf where it is impossible to move the wheels 36 under such shelf. This situation may occur, for example, when a pallet is loaded onto a trailer and the wheels of the trailer block the movement of wheels 36 under the trailer. To achieve such a lift, the forks 46 are first moved at least partially under the object until the wheels 36 or frame member 32 strike the blocking structure. The lifting mechanism 40 is then energized sufficiently to engage the forks 46 under the object so that, as the skid-steer loader is backed away from the shelf, the object will slide somewhat over the edge of the shelf. The upward force on the forks 46 is then reduced and the skid-steer loader is moved forward against the blocking structure to further extend the forks 46 under the load. This process is repeated as necessary until the forks 46 are fully inserted under the load, whereupon the load is lifted and moved in normal fashion. In this manner a load having a magnitude larger than the rating of a standard pallet fork attachment may be moved from a position that is not accessible to the prior art device illustrated in FIGS. 1 and 2.

FIG. 5 illustrates a lifting apparatus 60 including the lifting device 30 of FIGS. 3 and 4 attached to a prior art skid-steer loader 62. The skid-steer loader moves on a pair of front wheels 64 and a pair of rear wheels 66. As is known in the art, the front and rear wheels 64, 66 on each respective side of a skid-steer loader are driven together with a chain drive. The vehicle is turned by driving the paired wheels on opposite sides of the loader 62 in opposite directions. This type of operation causes the wheels to skid during a turn, thus the name skid-steer loader. Such skidding will destroy sod or other surfaces over which the loader is operated. The lifting apparatus 60 is illustrated in a mode of operation where the front wheels 64 are lifted off of the ground surface 68 by moving the boom arm 70 downward beyond the point where the two portions of universal coupler 72 align naturally. Because frame member 32 is held in position by wheels 36, the reaction to the downward movement of boom 70 is an upward movement of front wheels 64. In this position, the lifting apparatus 60 may be turned by driving the opposed rear wheels 66 in opposite directions. The hard connection provided by coupler 72 and the action of casters 38 allow the lifting apparatus 60 to make smooth turns without significant damage to the underlying surface 68. Since this type of operation is inherently less stable than operation with all six wheels on the ground, an inclinometer 74 may be provided at a convenient location on the lifting apparatus 60 in view of the operator so that movement on hills exceeding a predetermined slope may be avoided. Furthermore, the hydraulic lifting mechanism 40 may include automatic controls for limiting the weight that may be lifted on the forks 42.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

I claim as my invention:

1. A load lifting device comprising:
a skid-steer loader having a boom arm;
an auxiliary lifting apparatus connected to an end of the boom arm by a hard connection, the auxiliary lifting apparatus further comprising:
a generally C-shaped frame member fixedly attached to the end of the boom arm proximate a center of the C-shape; and
a caster assembly attached proximate each end of the C-shaped frame member;
a lifting mechanism attached to the C-shaped frame member, the lifting mechanism comprising a load-bearing member extending beyond the ends of the C-shaped frame member.

2. The load lifting device of claim 1, wherein a swivel axis of each caster is disposed in a vertical plane lying proximate a center of the load-bearing member.

3. The load lifting device of claim 4, wherein the lifting mechanism comprises a fork having a horizontal length of approximately 60 inches, and wherein the distance between the mounting device and a swivel axis of the caster assembly is approximately 30 inches.

4. The load lifting device of claim 1, further comprising an inclinometer attached to the device.

5. A load lifting device comprising:
a frame member including a mounting device for making a hard connection to a boom arm of a skid-steer loader;
a caster assembly attached to the frame member opposed the mounting device; and
a lifting mechanism attached to the frame member for raising and lowering a load, the lifting mechanism comprising a load-bearing member extending beyond the caster assembly in a direction away from the mounting device.

6. The load lifting device of claim 5, wherein a swivel axis of the caster assembly is aligned in a vertical plane with a center of the load bearing member.

7. The load lifting device of claim 5, wherein the lifting mechanism comprises a fork having a horizontal length of approximately 60 inches, and wherein the distance between the mounting device and a swivel axis of the caster assembly is approximately 30 inches.

8. The load lifting device of claim 5, and further comprising an inclinometer attached to the device.
